(19) United States
(12) Patent Application Publication
(10) Pub. No.: US 2007/0097097 A1
(43) Pub. Date: May 3, 2007

(54) Laser type coordinate sensing system for touch module

(76) Inventor: Jerry Liao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/588,404

(22) Filed: Oct. 27, 2006

(30) Foreign Application Priority Data
Oct. 28, 2005 (TW) 94137978

(51) Int. Cl. G09G 5/00

(52) U.S. Cl. 345/175

(57) ABSTRACT

A laser type coordinate sensing system for touch module includes an X-direction light emitting array, an X-direction light receiving array, a Y-direction light emitting array, and a Y-direction light receiving array provided at four sides of a touch area on a substrate, so that a plurality of X-direction laser beams projected from the X-direction light emitting array and a plurality of Y-direction laser beams projected from the Y-direction light emitting array densely and orthogonally intersect with one another in the touch area on the substrate. The laser type coordinate sensing system for touch module may be associated with a display panel to form a laser type touch panel.

### FIELD OF THE INVENTION

The present invention relates to a touch position sensor, and more particularly to a laser type coordinate sensing system for touch module. The coordinate sensing system produces a plurality of densely and orthogonally intersected laser beams in a touch area on a substrate, so as to sense coordinate positions of a point in the touch area touched by a user's finger.

### BACKGROUND OF THE INVENTION

With various kinds of powerful functions, such as word processing, equipment controlling, drawing, game software executing, and multimedia production and playback, computer has become more and more important to all kinds of business. Time being spent by people everyday in operating computers is increasingly extended. Among others, computer research and development engineers, secretarial staff, data input operators, etc. spend particularly long time in work hours to use various kinds of computer-related input devices, such as keyboard, mouse, touch panel, touch display, and trackball, so as to input data or control the computer.

Among various input devices, touch display integrates a general display with the touch-and-select function. A user may select and input a function to be executed simply from a menu exactly viewed on the display. Apart from the computers, there are still many other electronic products that also employ the technique of touch display.

Generally, a currently available touch display includes an upper touch layer, a lower touch layer, and a display panel. The touch display may adopt the currently available technique for thin-film resistive touch screen or liquid crystal display panel. A spacer dot matrix is provided between the upper and lower touch layers to form an assembly. The assembly is then set on a substrate made of an electrically conductive material. The upper touch layer and the lower touch layer together form a touch panel. When the touch panel of the touch display is touched, the X, Y coordinate positions of the touched point could be detected via the spacer dot matrix, so that a signal indicating the detected touch is sent out via a signal line.

The touch signal sent out by the signal line of the upper and lower touch layers is digitalized by an analog to digital converter (A/D), and a microcontroller calculates from the digitalized signal the coordinate positions of the touched point on the touch panel.

In practical use of the conventional touch display, the coordinate positions of the touched point are not always accurately detected. There are also other problems, such as insufficient mechanical endurance and durability of the touch panel. For example, in the currently available thin-film resistive touch screen technique, the spacer dot matrix provided between the upper and lower touch layers does not provide accurate coordinate position detection when the touch layers are touched. Moreover, the thin-film resistive coating on the touch screen tends to change in electric properties after being used over a period of time, and would therefore adversely affect the operation and accuracy of the touch panel. Moreover, the thin-film resistive touch screen would be damaged and become useless when the surface of the touch layers is scratched by a sharp article.

### SUMMARY OF THE INVENTION

A primary object of the present invention is to provide a laser type coordinate sensing system for touch module capable of accurately and precisely sensing coordinate positions of a touched point. The system produces a plurality of densely and orthogonally intersected laser beams in a touch area on a surface, so that coordinate positions of a point in the touch area touched by a user's finger may be easily calculated from changes in laser beams being received in the system.

Another object of the present invention is to provide a laser type coordinate sensing system for touch module that may be associated with a display panel, so that an operator may easily control a target apparatus simply by touching the display panel.

To achieve the aforementioned objects, the present invention includes an X-direction light emitting array, an X-direction light receiving array, a Y-direction light emitting array, and a Y-direction light receiving array provided at four sides of a touch area on a substrate, so that a plurality of X-direction laser beams projected from the X-direction light emitting array and a plurality of Y-direction laser beams projected from the Y-direction light emitting array densely and orthogonally intersect with one another in the touch area on the substrate. The laser type coordinate sensing system for touch module may be associated with a display panel to form a laser type touch panel.

As compared with the conventional touch display, the laser type coordinate sensing system for touch module according to the present invention effectively overcomes the problems of inaccurate detection of coordinate positions, changed electric properties, poor durability, etc. With the a plurality of densely and orthogonally intersected laser beams formed in the touch area on a touch panel or touch display, it is possible to accurately and precisely detect the coordinate positions of any point in the touch area touched by an operator's finger. Moreover, since laser beam technique is employed in the present invention, the whole coordinate sensing system has stable electric properties that do change with time. Further, the present invention is more durable than other conventional coordinate sensing structures.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a plan view showing a laser type coordinate sensing system for touch module according to a first embodiment of the present invention;

FIG. 2 shows the coordinate sensing system of FIG. 1 produces a plurality of intersected vertical and horizontal laser beams within a touch area;

FIG. 3 is an enlarged view of the circled area A in FIG. 2;

FIG. 4 is an enlarged view of the circled area B in FIG. 2;

FIG. 5 is an enlarged view of the circled area C in FIG. 2;

FIG. 6 shows the application of the laser type coordinate sensing system of the present invention in a touch display;

FIG. 7 is a sectional view taken along line 7-7 of FIG. 6;

FIG. 8 is a plan view showing a laser type coordinate sensing system for touch module according to a second embodiment of the present invention;

FIG. 9 is a plan view showing a laser type coordinate sensing system for touch module according to a third embodiment of the present invention; and

FIG. 10 is a plan view showing a laser type coordinate sensing system for touch module according to a fourth embodiment of the present invention.

### DETAILED DESCRIPTION OF THE PREFERRED EMBODIMENTS

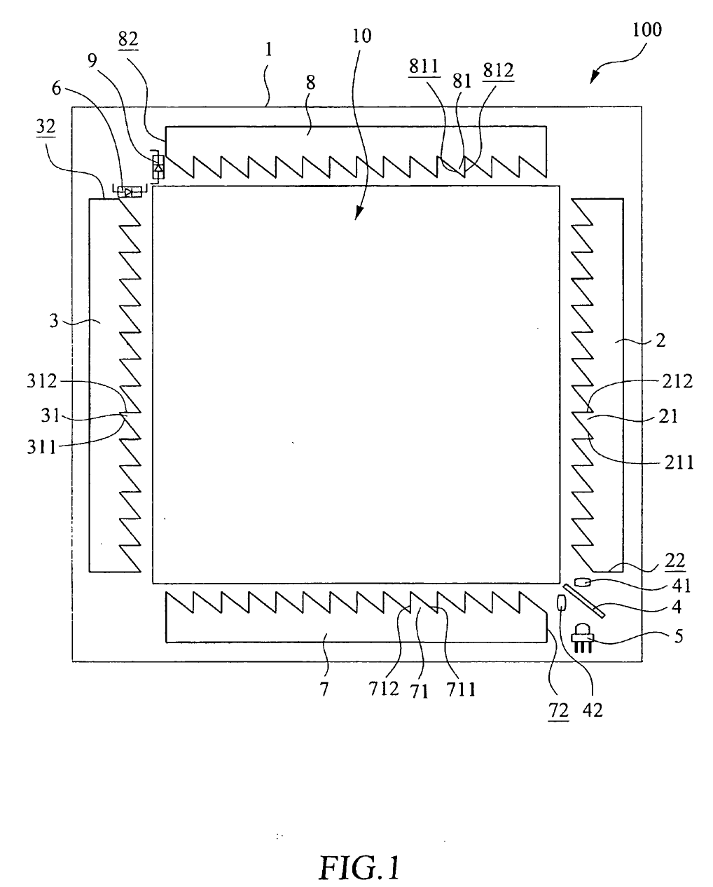

Please refer to FIG. 1 that is a plan view showing a laser type coordinate sensing system for touch module according to a first embodiment of the present invention. For the purpose of conciseness, the present invention is also briefly referred to as “the coordinate sensing system” throughout this specification. As shown, the coordinate sensing system according to the first embodiment of the present invention is generally denoted a numeral reference 100, and includes a substrate 1. On a surface of the substrate 1, there is defined a touch area 10, within which a user may effectively execute touch-control operation.

An X-direction light emitting array 2 is provided to one vertical side of the touch area 10, and an X-direction light receiving array 3 is provided to another vertical side of the touch area 10 opposite to and corresponding to the X-direction light emitting array 2. The X-direction light emitting array 2 includes a plurality of laser light emitting units 21 located at one side of the array 2 facing toward the touch area 10. Each of the laser light emitting units 21 has a half-reflection inclined plane 211 and a vertical plane 212. Similarly, the X-direction light receiving array 3 includes a plurality of laser light receiving units 31 located at one side of the array 3 facing toward the touch area 10. Each of the laser light receiving units 31 has a half-reflection inclined plane 311 and a vertical plane 312. Wherein, the half-reflection inclined planes 311 on the array 3 are one-to-one correspondingly located across from the half-reflection inclined planes 211 on the array 2.

An end of the X-direction light emitting array 2 is a light-in end 22, and a beam splitter 4 and a laser light generating unit 5 are provided in the vicinity of the light-in end 22. An end of the X-direction light receiving array 3 is a light-out end 32, and a laser beam receiving unit 6 is provided in the vicinity of the light-out end 32.

A Y-direction light emitting array 7 is provided to one horizontal side of the touch area 10, and a Y-direction light receiving array 8 is provided to another horizontal side of the touch area 10 opposite to and corresponding to the Y-direction light emitting array 7. The Y-direction light emitting array 7 includes a plurality of laser light emitting units 71 located at one side of the array 7 facing toward the touch area 10. Each of the laser light emitting units 71 has a half-reflection inclined plane 711 and a vertical plane 712. Similarly, the Y-direction light receiving array 8 includes a plurality of laser light receiving units 81 located at one side of the array 8 facing toward the touch area 10. Each of the laser light receiving units 81 has a half-reflection inclined plane 811 and a vertical plane 812. Wherein, the half-reflection inclined planes 811 on the array 8 are one-to-one correspondingly located across from the half-reflection inclined planes 711 on the array 7.

An end of the Y-direction light emitting array 7 is a light-in end 72. Half of the light energy of the laser light generated by the laser light generating unit 5 is reflected by the beam splitter 4 to project toward the light-in end 72. An end of the Y-direction light receiving array 8 is a light-out end 82, and a laser beam receiving unit 9 is provided in the vicinity of the light-out end 82.

In implementing the present invention, a first collimating mirror 41 is provided between the beam splitter 4 and the X-direction light emitting array 2, and a second collimating mirror 42 is provided between the beam splitter 4 and the Y-direction light emitting array 7.

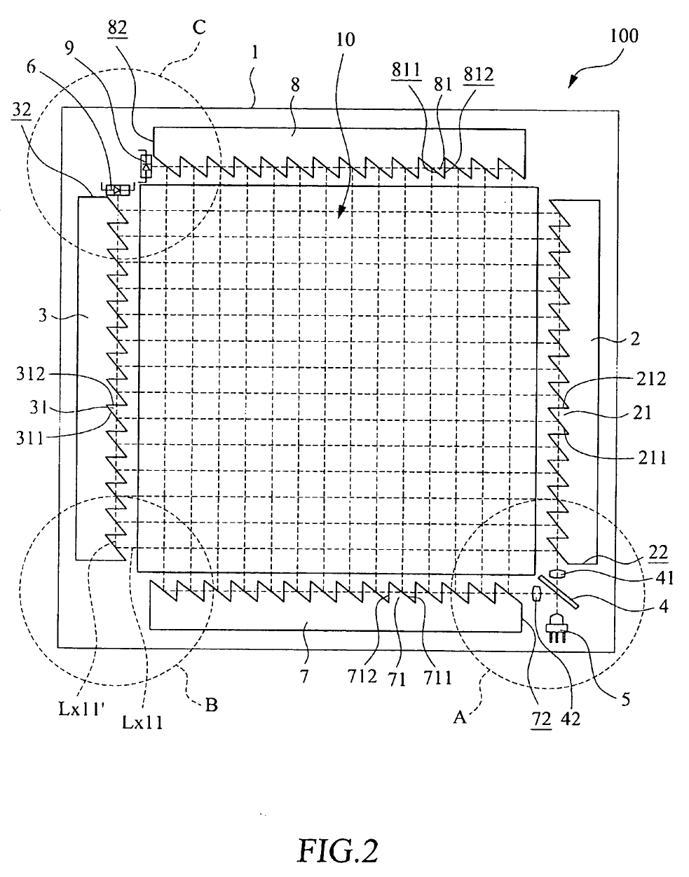

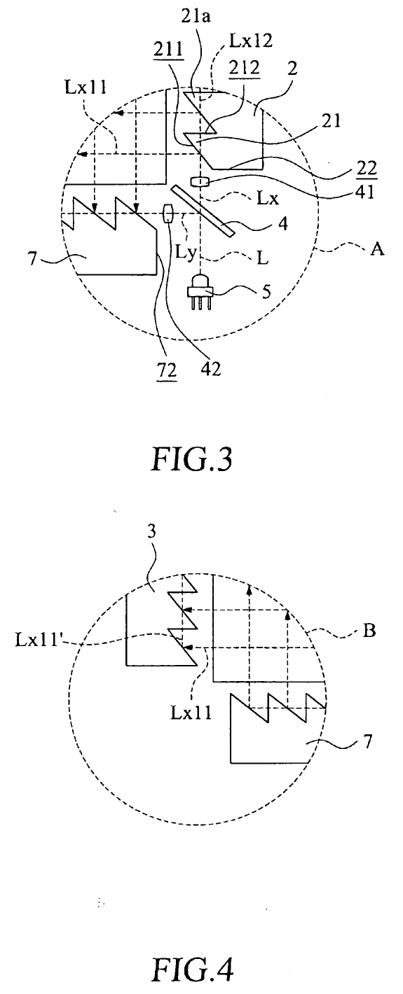

Please refer to FIGS. 2 and 3 at the same time. When the laser light L generated by the laser light generating unit 5 reaches at the beam splitter 4, part of the light energy, which is referred to as laser light Lx, passes through the beam splitter 4 to project toward the light-in end 22 of the X-direction light emitting array 2, while another part of the light energy, which is referred to as laser light Ly, is reflected by the beam splitter 4 and projected toward the light-in end 72 of the Y-direction light emitting array 7.

The laser light Lx is split by the half-reflection inclined plane 211 of a first one of the laser light emitting units 21 on the X-direction light emitting array 2 to produce a horizontal laser beam Lxll, while another part of the X-direction laser light Lx passes through the vertical plane 212 of the first laser light emitting unit 21 to produce a vertical laser beam Lxl2. The vertical laser beam Lxl2 passes through the vertical plane 212 of the first laser light emitting unit 21 and is further split by the half-reflection inclined plane of a second laser light emitting unit 21a to produce a horizontal and a vertical laser beam. In this manner, a plurality of horizontally paralleled laser beams are separately projected from the laser light emitting units 21 of the X-direction light emitting array 2.

Please refer to FIGS. 2, 3, and 4 at the same time. The horizontal laser beam Lx11 horizontally passes across the touch area 10 to project toward the half-reflection inclined plane 311 of a first one of the laser light receiving units 31 in the X-direction light receiving array 3, and is reflected at the half-reflection inclined planes 311 to produce a vertical laser beam Lxll′. The above-described components and light paths together with a laser beam reflective power of the half-reflection inclined planes 211 of the laser light emitting units 21 enable the producing of a plurality of densely and uniformly distributed X-direction parallel laser beams in the whole surface of the touch area 10.

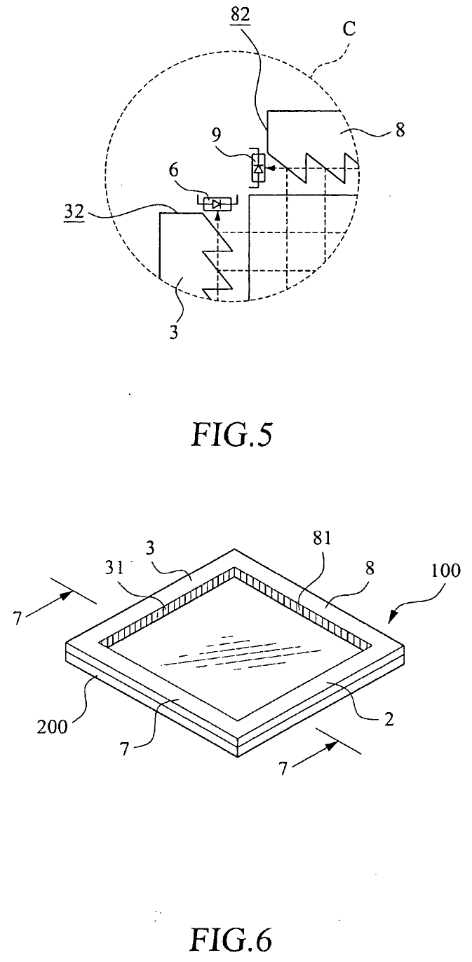

Please refer to FIGS. 2 and 5 at the same time. When the received X-direction laser beams are reflected by the half-reflection inclined planes 311 of the laser light receiving units 31 in the X-direction light receiving array 3 and received by the laser beam receiving unit 6, they are processed using conventional signal amplifying circuit and A/D converter to convert into digital signals having 256 signal levels, for example.

Similarly, through the same working principle, the Y-direction laser light Ly projected by the beam splitter 4 toward the light-in end 72 of the Y-direction light emitting array 7 may produce a plurality of densely and uniformly distributed vertically paralleled laser beams in the whole surface of the touch area 10.

When the received X-direction laser beams reflected by the half-reflection inclined planes 311 of the laser light receiving units 31 of the X-direction light receiving array 3 are received by the laser beam receiving unit 6, and the received Y-direction laser beams reflected by the half-reflection inclined planes 811 of the laser light receiving units 81 of the Y-direction light receiving array 8 are received by the laser beam receiving unit 9, they are processed using conventional signal amplifying circuit and AID converter to convert into digital signals having 256 signal levels, for example. Thereafter, the X and Y coordinate positions of a point on the surface of the touch area 10 touched by a user's finger may be calculated using a general digital signal processor based on the levels of the digital signal.

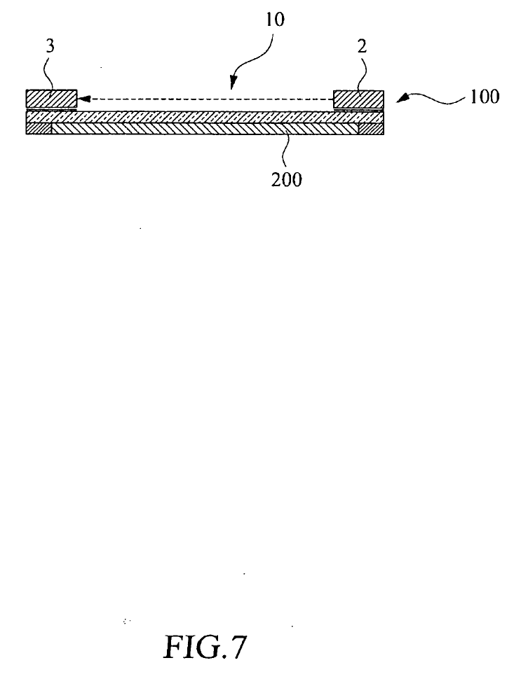

The present invention may be employed in any applied product that requires sensing of coordinate positions of a point touched by a user. The present invention may also be used in other applied products, such as a touch display. FIG. 6 is a perspective view showing the present invention used with a touch display, and FIG. 7 is a sectional view taken along line 7-7 of FIG. 6. As shown, the coordinate sensing system 100 according to the present invention is associated with a conventional display panel 200. The display panel 200 is provided at four sides of its surface with the X-direction light emitting array 2, the X-direction light receiving array 3, the Y-direction light emitting array 7, and the Y-direction light receiving array 8. The a plurality of X-direction laser beams projected from the X-direction light emitting array 2 and the a plurality of Y-direction laser beams projected from the Y-direction light emitting array 7 are densely and orthogonally intersected with one another in the touch area 10 on the substrate 1, and are sensed by the X-direction light receiving array 3 and the Y-direction light receiving array 8, respectively.

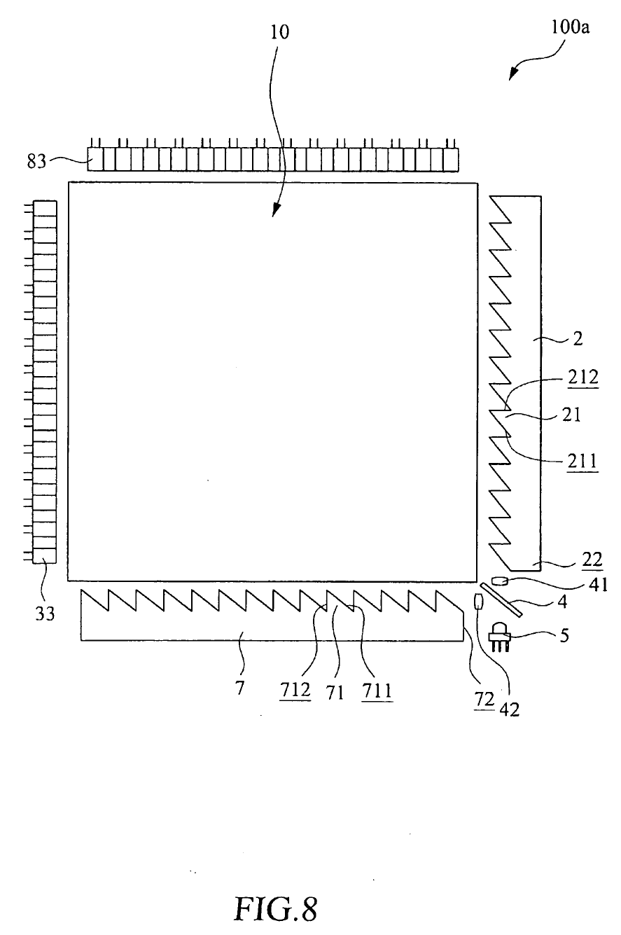

FIG. 8 is a plan view showing a laser type coordinate sensing system for touch module 100a according to a second embodiment of the present invention. The second embodiment is generally structurally similar to the first embodiment, except for an X-direction light receiving diode array that replaces the X-direction light receiving array 3 and the laser beam receiving unit 6 in the first embodiment, and a Y-direction light receiving diode array that replaces the Y-direction light receiving array 8 and the laser beam receiving unit 9 in the first embodiment.

The X-direction light receiving diode array includes a plurality of light receiving laser diodes 33 arranged side by side. The laser beams projected from the laser light emitting units 21 of the X-direction light emitting array 2 are one-to-one correspondingly received by the light receiving laser diodes 33. Similarly, the Y-direction light receiving diode array includes a plurality of light receiving laser diodes 83 arranged side by side. The laser beams projected from the laser light emitting units 71 of the Y-direction light emitting array 7 are one-to-one correspondingly received by the light receiving laser diodes 83.

It is understood the light receiving laser diodes 33 and 83 may also be replaced by, for example, contact image sensors (CIS), or other suitable light receiving elements.

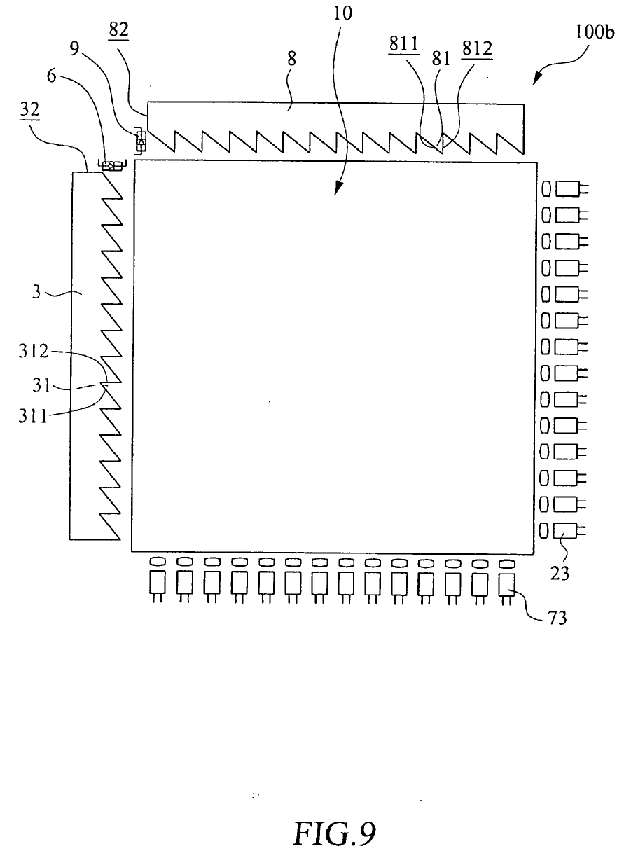

FIG. 9 is a plan view showing a laser type coordinate sensing system for touch module 100b according to a third embodiment of the present invention. The third embodiment is generally structurally similar to the first embodiment, except for an X-direction light emitting laser diode array that replaces the X-direction light emitting array 2, the beam splitter 4, and the laser light generating unit 5 in the first embodiment; and a Y-direction light emitting laser diode array that replaces the Y-direction laser light emitting array 7, the beam splitter 4, and the laser light generating unit 5 in the first embodiment.

The X-direction light emitting laser diode array includes a plurality of light emitting laser diodes 23 arranged side by side. The laser beams emitted from the light emitting laser diodes 23 are one-to-one correspondingly received by the laser light receiving units 31 of the X-direction light receiving array 3. Similarly, the Y-direction light emitting laser diode array includes a plurality of light emitting laser diodes 73 arranged side by side. The laser beams projected from the light emitting laser diodes 73 are one-to-one correspondingly received by the laser light receiving units 81 of the Y-direction light receiving array 8.

A collimating mirror is mounted in front of each of the light emitting laser diodes 23 and 73.

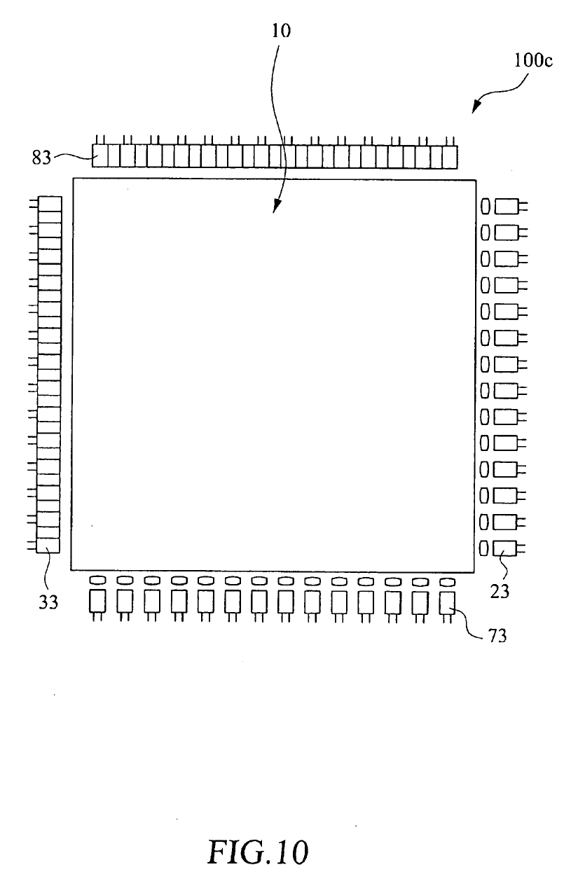

FIG. 10 is a plan view showing a laser type coordinate sensing system for touch module 100c according to a fourth embodiment of the present invention. The fourth embodiment includes an X-direction light emitting laser diode array consisting of a plurality of light emitting laser diodes 23, a Y-direction light emitting laser diode array consisting of a plurality of light emitting laser diodes 73, an X-direction light receiving diode array consisting of a plurality of light receiving laser diodes 33, and a Y-direction light receiving diode array consisting of a plurality of light receiving laser diodes 83.

In the laser type coordinate sensing system for touch module configured as FIG. 10, laser beams emitted from the light emitting laser diodes 23 are one-to-one correspondingly received by the light receiving laser diodes 33. And, laser beams emitted from the light emitting laser diodes 73 are one-to-one correspondingly received by the light receiving laser diodes 83.

While the invention has been described in connection with what is presently considered to the most practical and preferred embodiments, it is to be understood that the invention is not to be limited to the disclosed embodiment, but on the contrary, is intended to cover various modifications and equivalent arrangement included within the spirit and scope of the appended claims.

What is claimed is:

1. A coordinate sensing system for a touch module, comprising:
a substrate being defined on a surface with a touch area of the touch module;
a laser light generating device for generating a laser light;
a laser beam receiving device;
an X-direction light emitting array provided to a vertical side of the touch area, and having a light-in end for receiving the laser light generated by the laser light generating device, so as to project a plurality of parallel X-direction laser beams across the touch area on the substrate;
an X-direction light receiving array provided to another vertical side of the touch area opposite to and corresponding to the X-direction light emitting array, so as to receive the X-direction laser beams projected by the X-direction light emitting array and then project the received laser beams via a light-out end to the laser beam receiving device;
a Y-direction light emitting array provided to a horizontal side of the touch area, and having a light-in end for receiving the laser light generated by the laser light generating device, so as to project a plurality of parallel Y-direction laser beams across the touch area on the substrate; and
a Y-direction light receiving array provided to another horizontal side of the touch area opposite to and corresponding to the Y-direction light emitting array, so as to receive the Y-direction laser beams projected by the Y-direction light emitting array and then project the received laser beams via a light-out end to the laser beam receiving device;
whereby the a plurality of X-direction laser beams projected from the X-direction light emitting array and the a plurality of Y-direction laser beams projected from the Y-direction light emitting array densely and orthogonally intersect with one another in the touch area on the substrate.

2. The coordinate sensing system as claimed in claim 1, wherein the laser light generating device including:
at least one laser light generating unit located in the vicinity of the light-in end of the X-direction light emitting array; and
a beam splitter located among the laser light generating unit, the light-in end of the X-direction light emitting array, and the light-in end of the Y-direction light emitting array.

3. The coordinate sensing system as claimed in claim 1, wherein the X-direction light emitting array includes a plurality of laser light emitting units, each of which has a half-reflection inclined plane and a vertical plane; and the Y-direction light emitting array includes a plurality of laser light emitting units, each of which has a half-reflection inclined plane and a vertical plane.

4. The coordinate sensing system as claimed in claim 1, wherein the X-direction light receiving array includes a plurality of laser light receiving units, each of which has a half-reflection inclined plane and a vertical plane; and the Y-direction light receiving array includes a plurality of laser light receiving units, each of which has a half-reflection inclined plane and a vertical plane.

5. The coordinate sensing system as claimed in claim 1, further comprising a display panel; and the X-direction light emitting array, the X-direction light receiving array, the Y-direction light emitting array, and the Y-direction light receiving array being separately provided at four sides of the display panel.

6. A coordinate sensing system for a touch module, comprising:
a substrate being defined on a surface with a touch area;
an X-direction light emitting laser diode array provided to a vertical side of the touch area, and having a plurality of light emitting laser diodes arranged side by side, so as to project a plurality of parallel X-direction laser beams across the touch area on the substrate;
an X-direction light receiving diode array provided to another vertical side of the touch area opposite to and corresponding to the X-direction light emitting laser diode array, so as to receive the X-direction laser beams projected by the light emitting laser diodes of the X-direction light emitting laser diode array;
a Y-direction light emitting laser diode array provided to a horizontal side of the touch area, and having a plurality of light emitting laser diodes arranged side by side, so as to project a plurality of parallel Y-direction laser beams across the touch area on the substrate; and
a Y-direction light receiving diode array provided to another horizontal side of the touch area opposite to and corresponding to the Y-direction light emitting laser diode array, so as to receive the Y-direction laser beams projected by the light emitting laser diodes of the Y-direction light emitting laser diode array;
whereby the a plurality of X-direction laser beams projected from the X-direction light emitting laser diode array and the a plurality of Y-direction laser beams projected from the Y-direction light emitting laser diode array densely and orthogonally intersect with one another in the touch area on the substrate.

7. The coordinate sensing system as claimed in claim 6, further comprising a display panel; and the X-direction light emitting laser diode array, the X-direction light receiving diode array, the Y-direction light emitting laser diode array, and the Y-direction light receiving diode array being separately provided at four sides of the display panel.
